(19) United States
(12) Patent Application Publication
(10) Pub. No.: US 2022/0228627 A1
(43) Pub. Date: Jul. 21, 2022

(54) UNIVERSAL RAIL FOR MOBILE RACKING

(71) Applicant: FLEXSPACE 360, Charleston, SC (US)

(72) Inventors: Todd Jessup, Charleston, SC (US); Janusz Pierdos, Charleston, SC (US)

(73) Assignee: FLEXSPACE 360, Charleston, SC (US)

(21) Appl. No.: 17/154,252

(22) Filed: Jan. 21, 2021

(51) Int. Cl. F16C 29/00; B65G 1/10

(52) U.S. Cl. CPC F16C 29/005; F16C 2326/58; B65G 1/10

(57) ABSTRACT

A rail for mobile racking has a continuous groove formed in ae first surface. A second surface is opposite the first surface is substantially flat on a top surface. The width of the universal rail between the first surface and the second surface is of reduced dimension from the first surface and the second surface. The rail may be mounted with the first surface positioned above the second surface when a groove within the elongated universal rail is to be provided for casters having a tongue on a circumference of the caster. The elongated universal rail may be mounted within a floor with the second surface positioned above the first surface, providing a substantially flat surface as a rolling surface for casters not having a tongue formed therein. Reduced dimensions of the sides relative to the first and second surfaces receive concrete therein to hold the rail in place.

### BACKGROUND OF THE INVENTION

Racks are used within warehouses for storing articles, goods, palletized items, and materials. To conserve space, racks may be moveable within the warehouse or other storage facility. Movable racks traverse rails that are cast into concrete that forms the floor of the warehouse. The racks can be pushed together to conserve space. When access to a particular item on a particular rack is required, racks are moved linearly across rails embedded in the warehouse floor to create an aisle for access to the particular rack by people or vehicles such as forklifts. The aisle is created by pushing other racks together to form the aisle.

Using moveable racks to conserve space is particularly useful in refrigerated (cold storage) warehousing. By reducing the total amount of space occupied by racks, the cubic area that must be cooled is reduced, thereby reducing energy consumption and the associated expense, as well as reducing adverse environmental effects.

Commonly, racks used in warehousing comprise two or more rails. The rails are mounted in the floor. Typically, concrete surrounds the sides and bottom of the rails to hold the rails in place. The racks are constructed with casters on the racks that roll along the rails. At least one of the rails has a groove formed therein that receives a tongue of a caster. Other rails, such as intermediate rails, do not have a groove formed in the top surface of the rails. These rails are weight bearing to support for the racks that the concrete floor is unable to adequately provide. Most typically, casters that are at ends of the racks have a tongue formed therein to guide the caster within the rail. Intermediate rails may not have a tongue receiving groove, which reduces friction.

There is a need for a universal rail that provides a groove for the tongue of a caster when needed, but also has a flat surface for casters that do not have a tongue formed therein.

### SUMMARY OF THE INVENTION

The universal rail of the invention comprises a first surface having a continuous groove formed in the first surface. A second surface is opposite the first surface and does not have a groove formed therein and is substantially flat on a top surface. The width of the universal rail between the first surface and the second surface is of reduced dimension from the first surface and the second surface. The rail may be mounted with the first surface positioned above the second surface when a groove within the elongated universal rail is to be provided. The elongated universal rail may also be mounted within the floor with the second surface positioned above the first surface, providing a substantially flat surface as a rolling surface for casters not having a tongue formed therein.

The reduced dimensions of the sides receive concrete therein, so that the portions of the side adjoining the first surface and adjoining the second surface extend outwardly from the remainder of the sides. Concrete fills the sides to hold the rail in place.

### BRIEF DRAWING DESCRIPTION

FIG. 1 is a partial perspective view of a mobile racking as used in a warehouse.

FIG. 2 is a partial perspective view of an elongated universal rail for mobile racking according to the invention.

FIG. 3 is a partial perspective view of the elongated universal rail for mobile racking with the first surface mounted above the second surface and within concrete for receiving a caster having a tongue formed therein.

FIG. 4 is a partial perspective view of the elongated universal rail for mobile racking with the second surface mounted above the first surface and within concrete for receiving a caster that does not have a tongue formed therein.

FIG. 5 is an elevation of the universal rail for mobile racking shown from the end of the racking.

FIG. 6 is a side elevation of the elongated universal rail for the mobile racking.

FIG. 7 is a plan view of the first surface of the elongated universal rail for mobile racking.

FIG. 8 is a plan view of the second surface of the elongated universal rail for the mobile racking system.

### DESCRIPTION OF PREFERRED EMBODIMENTS

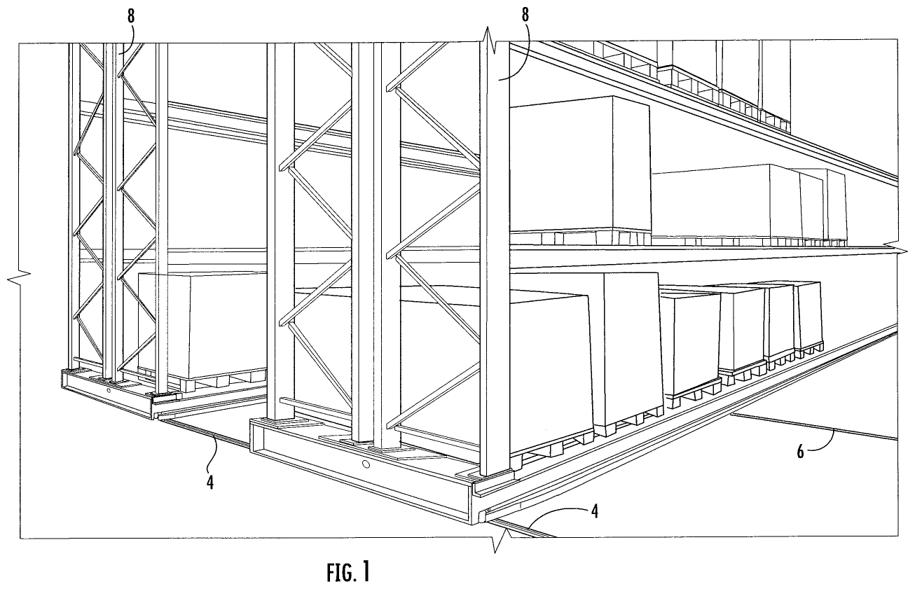

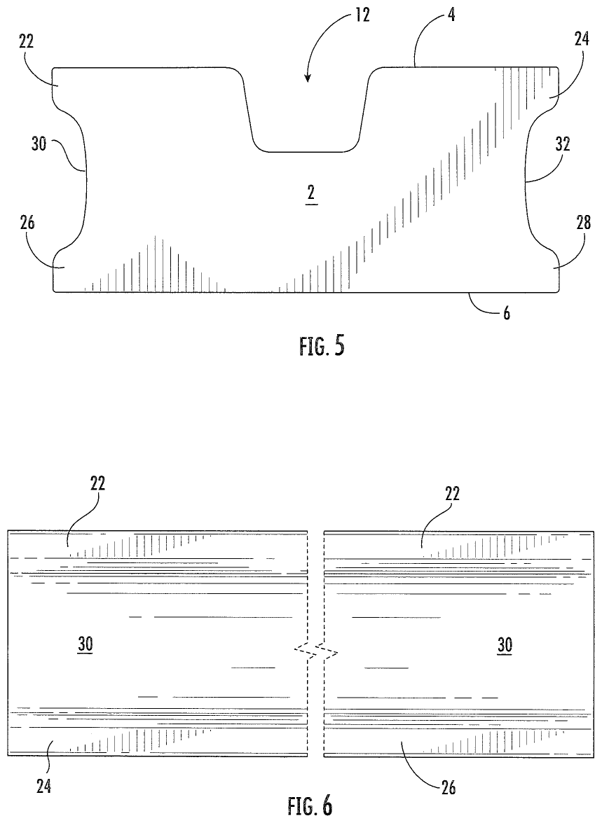

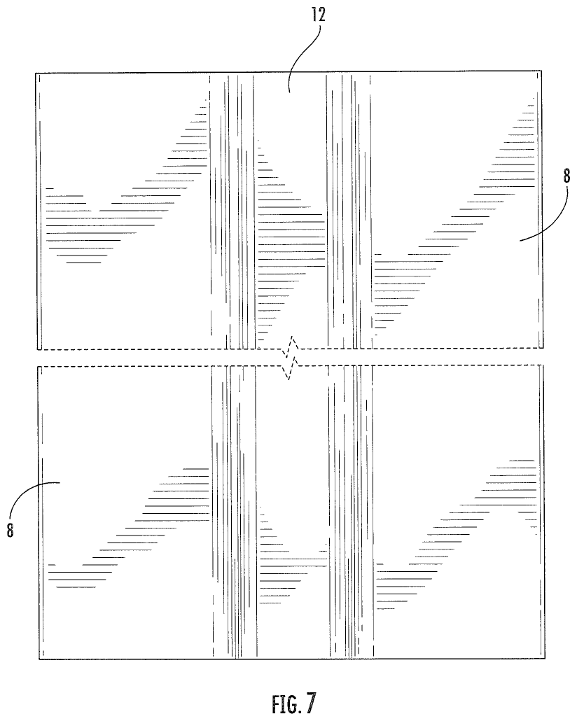

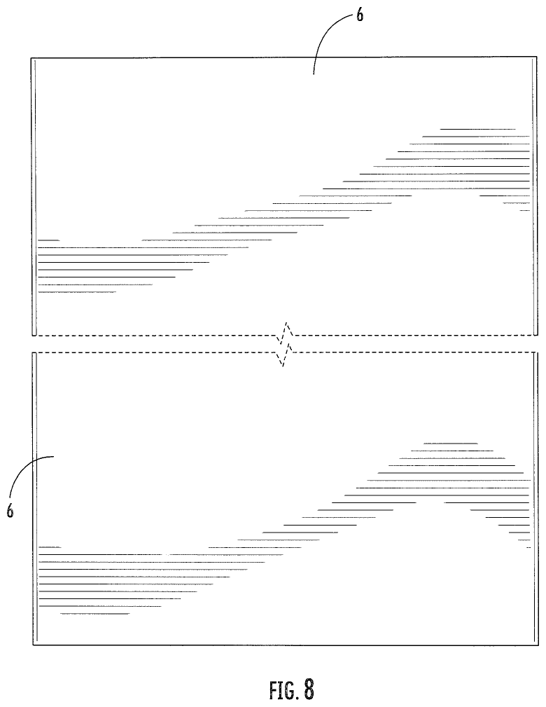

FIG. 5 shows an elevation of an end of the universal rail 2 according to the invention. The rail is sufficiently elongated to accommodate movement of several racks 8 along the rail in a typical warehousing situation. FIG. 1. The opposite end of the universal rail will typically be identical in appearance, dimensions and structure to the rail as shown in the elevation of FIG. 5.

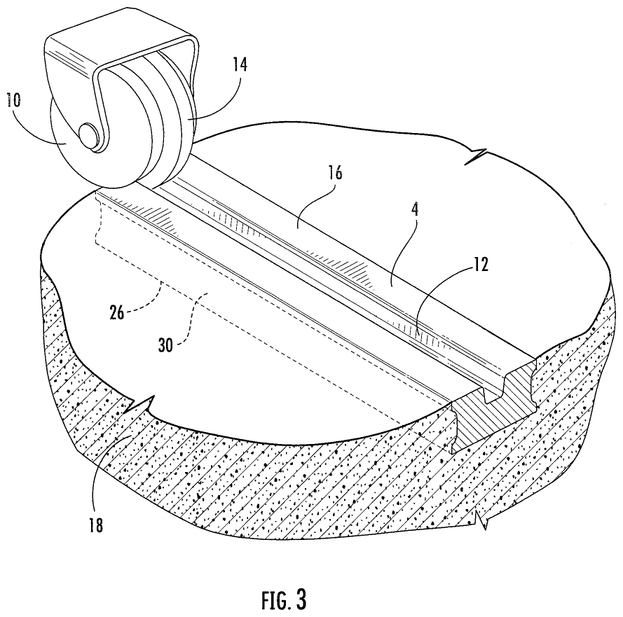

A first surface 4 of the rail has a groove 12 formed therein. As shown in FIG. 5, the first surface of the rail is the top surface of the rail. The groove is constructed and arranged to receive a tongue formed in a caster 10 that is mounted to the mobile racking 8. FIG. 3. The dimensions of the groove may be formed to accommodate the dimensions of the tongue of the caster. On each side of the groove are substantially flat surfaces 16 for receiving a caster wheel as shown in FIG. 3. The caster has the tongue formed substantially in the center of the caster, with the surfaces of the wheel on either side of the tongue constructed to roll upon the upper and flat surface portions of the first surface. The tongue positions the caster on the rail as the caster rolls on the rail.

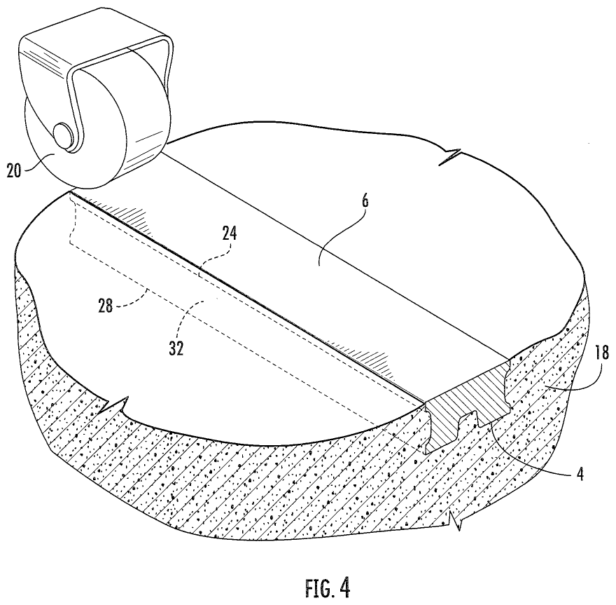

The second surface 6 of the elongated universal rail according to the invention is substantially flat. Second surface 6 accommodates wheels of casters 20 similar to that shown in FIG. 4, which do not have a tongue for guiding a caster and the mobile racking along the rail. In use, mobile racking typically uses a caster having a tongue on one or both ends of the mobile racking, while intermediate casters that are used with the racking use casters having a wheel that does not have a tongue as shown in FIG. 4. In one embodiment, the distance, or width, from a first end of the first surface 4 of the rail to the opposite end of the first surface of the rail, as demonstrated in FIG. 5, is substantially the same as the distance, or width, from a first end of the second surface 6 of the rail to the opposite end of the second surface of the rail.

The intermediate casters bear weight of the racking and its contents. It is not always necessary to have a tongue that provides guidance of the mobile racking along the rail. It is usually sufficient to have casters having tongues at each end of each mobile racking unit.

The universal rail is mounted within concrete 18 as shown in FIG. 3 and FIG. 4. The universal rail allows the same rail to be used with casters having a tongue and with casters which do not have a tongue as demonstrated by FIG. 3 and FIG. 4. The universal rail is inverted so that the first surface is above the second surface, as shown in FIG. 3, or is positioned as shown in FIG. 4, wherein the first surface is below the second surface depending upon whether or not a caster with a tongue, or with no tongue, will traverse the rail.

The structure of the sides of the universal rail allow the universal rail to be used in either the application shown in FIG. 3 or in the application shown in FIG. 4. The universal rail has a first concave side 30 that joins first surface 4 and second surface 6. The first concave side extends outwardly where the first concave side joins the first surface to form a flange or shoulder 22. The first concave side also extends outwardly from the second surface where the first concave side joins the second surface to form a flange or shoulder 24. The second concave side 32, which is opposite the first concave side as shown in FIG. 5, is a mirror image of the first concave side. The second concave side joins the first surface and the second surface. The second concave side extends outwardly from the first surface where the second concave side joins the first surface, and the second concave side extends outwardly from the second surface where the second concave side joins the second surface to form flanges or shoulders 26,28.

The universal rail has a reduced dimension between the first concave side and the second concave side. The dimension of the side 30 is also reduced between where the first concave side joins the first surface and where the first concave side joins the second surface. The opposite side 32, being a mirror image of the first concave side, also has a reduced dimension between where the second concave side joins the first surface and where the second concave side joins the second surface. The reduced dimension at its smallest dimension between the first concave side and the second concave side, is less than 90% of the width of the first surface and less than 90% or the width of the second surface, with the width of the reduced dimension being taken on a line that is generally parallel with the first surface and the second surface.

The structure of the sides 30, 32 and the flanges or shoulders 22, 24, 26 and 28 allows concrete to enter the reduced dimension on the first concave side and the reduced dimension on the second concave side. The concrete 18 sets to the hold the universal rail in place by the flanges or shoulders that are positioned near the bottom of the universal rail, which is the case whether the first surface 4 or the second surface 6 is the bottom surface of the universal rail. See FIG. 3 and FIG. 4, wherein concrete filling the reduced concave dimensions of sides 30, 32 prevents the rail from being pulled out of the concrete, by filling the reduced dimension of the sides and covering the flanges or shoulders. This is true whether the first surface is on top as shown in FIG. 3, or whether the first surface is below the second surface as shown in FIG. 4.

In use, the universal rail is mounted within a concrete floor as shown in FIG. 3 and in FIG. 4. A base may be provided prior to pouring concrete 18 that is useful in leveling the rail. The base is not shown in the drawings. As shown in FIG. 1, a first universal rail for mobile racking is positioned in a concrete floor, and a second universal rail from mobile racking is mounted in a concrete floor of a warehouse. The rails are in a substantially parallel position. In the embodiment shown in FIG. 1, the first surface 4 of the universal rail is positioned above the second surface of the universal rail as demonstrated by FIG. 3. The second universal rail is positioned with the second surface 6 above the first surface as demonstrated by FIG. 4.

In one embodiment, the first surface 4 and the second surface 6 abut the top surface of the concrete without gaps between the rail and the concrete floor 18 when used as the upper surface of the rail. FIG. 3. Preferably, the first surface meets the sides 30, 32 of the rail forming corners at 90° with substantially no radius at the corners, and the second surface meets the sides 30, 32 of the rail forming corners at 90° with substantially no radius at the corners. By “substantially no radius” is meant as little radius as is feasible due to manufacturing constraints and structural requirements for the rails, and preferably no radius.

FIG. 1 demonstrates two mobile racks 8 mounted on universal rails. The rails allow the racks to be pushed close together by use of the rails and casters. In use, several mobile racks may be used in a warehouse and pushed together to reduce the amount of space necessary for providing multiple racks in a racking system. By moving the racks, a space is provided between rack that is sufficient for a forklift or other material handling device to traverse the space. Racks are separated sufficiently to take advantage of the space when necessary to either position or remove articles from the racks. The number of rails and casters used in a racking system is dependent upon the length of the racks and the weight capacity of the racks.

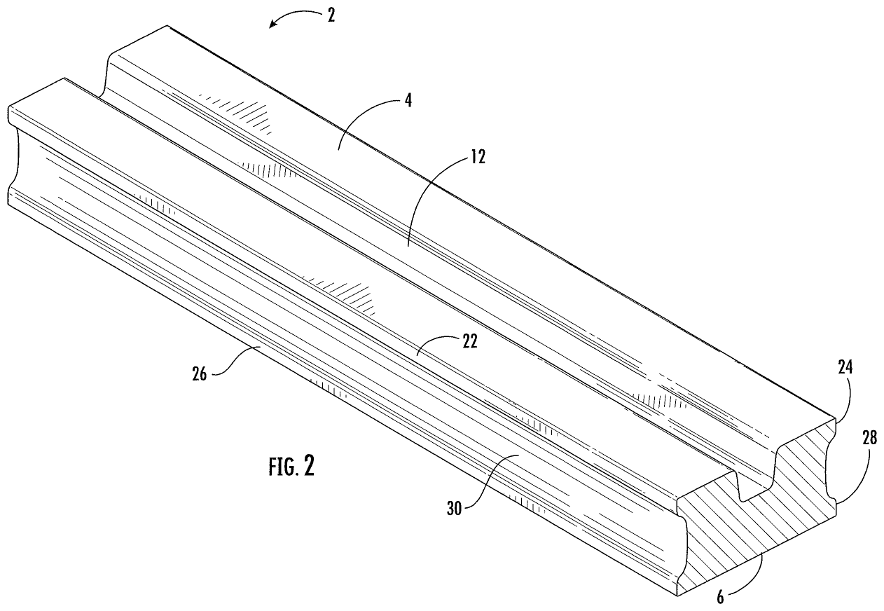

In a preferred embodiment, the reduced dimension of the sides 30,32 is accomplished by forming an arcuate shape between the first surface 4 of the universal rail for mobile racking and the second surface 6 of the universal rail for mobile racking. See FIG. 2 and FIG. 5. This arcuate surface may provide stress relief for the rail and for the concrete 18 and provide a surface that assists in holding the universal rail in place once the sides are filled with concrete as shown in the drawing figures.

In a preferred embodiment, the first surface 4 and the second surface 6 have the same surface dimension. In this way, there is no need to alter the process for mounting the rail whether the rail is to be mounted with the first surface exposed from the concrete, or whether the second substantially flat surface is mounted so that it is exposed from the concrete 18.

The universal rail may be formed of steel or steel alloy. The particular specification of the steel will depend upon the application. In some frozen food applications, the rail is formed to withstand fully loaded racking at temperatures as low as −30° F. The steel from which the rail is formed must withstand the temperature and load requirements. The universal rail may be formed by extruding the rail.

What is claimed:

1. A universal rail for mobile racking, comprising:
a first surface, the first surface comprising a continuous groove formed in the first surface, said groove of said first surface constructed and arranged to receive a caster of a mobile racking therein;
a second surface that is opposite the first surface;
a first concave side that joins the first surface and the second surface, the first concave side extending outwardly from the first surface where the first concave side joins the first surface, and the first concave side extending outwardly from the second surface where the first concave side joins the second surface,
a second concave side that joins the first surface and the second surface, the second concave side extending outwardly from the first surface where the second concave side joins the first surface, and the second concave side extending outwardly from the second surface where the second concave side joins the second surface,
the universal rail having a reduced dimension between the first concave side and the second concave side and between where the first concave side joins the first surface and where the second concave side joins the first surface, and between where the second concave side joins the first surface and where the second concave side joins the second surface.

2. A universal rail for mobile racking as described in claim 1, wherein the second surface is formed as substantially flat.

3. A universal rail for mobile racking as described in claim 1, wherein the groove is constructed and arranged to receive a tongue of the caster of the mobile racking therein.

4. A universal rail for mobile racking as described in claim 1, wherein, in use, the universal rail for mobile racking is positioned with the first surface above the second surface.

5. A universal rail for mobile racking as described in claim 1, wherein, in use, the universal rail for mobile racking is positioned with the second surface above the first surface.

6. A universal rail for mobile racking as described in claim 1, wherein, in use, a first universal rail for mobile racking is positioned with the first surface above the second surface and a second universal rail for mobile racking is positioned with the second surface above the first surface, and the first universal rail for mobile racking is positioned substantially parallel to the second universal rail for mobile racking.

7. A universal rail for mobile racking as described in claim 1, wherein the reduced dimension of the universal rail for mobile racking between the first concave side and the second concave side is formed by an arcuate construct between where the first concave side joins the first surface and where the second concave side joins the first surface and an arcuate construct between where the second concave side joins the first surface and where the second concave side joins the second surface.

8. A universal rail for mobile racking as described in claim 1, wherein the universal rail for mobile racking is sufficiently elongated to facilitate movement of industrial mobile racking in a warehouse.

9. A universal rail for mobile racking as described in claim 1, wherein the reduced dimension of the universal rail for mobile racking between the first concave side and the second concave side is constructed and arranged to receive concrete within the reduced dimension of the first concave side and reduced dimension of the second concave side, and the first concave side extending outwardly from the first surface where the first concave side joins the first surface, and the first concave side extending outwardly from the second surface where the first concave side joins the second surface, and the second concave side extending outwardly from the first surface where the second concave side joins the first surface, and the second concave side extending outwardly from the second surface where the second concave side joins the second surface hold the universal rail for mobile racking in position when concrete is positioned within the reduced dimension of the first concave side and reduced dimension of the second concave side.

10. A universal rail for mobile racking as described in claim 1, wherein the first surface of the rail and the second surface of the rail have substantially the same width.

11. A universal rail for mobile racking as described in claim 1, wherein the reduced dimension at its smallest dimension between the first concave side and the second concave side, is less than 90% of the width of the first surface and less than 90% or the width of the second surface, with the width of the reduced dimension being taken on a line that is generally parallel with the first surface and the second surface.

12. A universal rail for mobile racking as described in claim 1, wherein universal rail for mobile racking is mounted in concrete with the first surface substantially even with a top surface of a concrete floor formed of the concrete.

13. A universal rail for mobile racking as described in claim 1, wherein universal rail for mobile racking is mounted in concrete with the second surface substantially even with a top surface of a concrete floor formed of the concrete.

14. A universal rail for mobile racking as described in claim 1, wherein the first concave side joins the first surface forming a first corner at 90° with substantially no radius at the first corner and the second concave joins the first surface forming a second corner at 90° with substantially no radius at the second corner.
